(19) United States
(12) Patent Application Publication
(10) Pub. No.: US 2023/0147093 A1
(43) Pub. Date: May 11, 2023

(54) TRANSFORMER, POWER CONVERSION DEVICE, PRODUCT GROUP OF TRANSFORMER, AND MANUFACTURING METHOD FOR TRANSFORMER

(71) Applicant: Mitsubishi Electric Corporation, Tokyo (JP)

(72) Inventor: Kei Hayase, Tokyo (JP)

(73) Assignee: Mitsubishi Electric Corporation, Tokyo (JP)

(21) Appl. No.: 17/851,764

(22) Filed: Jun. 28, 2022

(30) Foreign Application Priority Data
Nov. 11, 2021 (JP) 2021-183800

(51) Int. Cl. H01F 27/28; H02M 3/335; H01F 27/24; H01F 27/08; H01F 41/06

(52) U.S. Cl. CPC H01F 27/28; H02M 3/33573; H01F 27/24; H01F 27/08; H01F 41/06

(57) ABSTRACT

A transformer that can easily cope with various input voltage specifications and that, has improved productivity is obtained. A transformer includes: a core portion for forming a magnetic circuit; and a primary-side winding and a secondary-side winding wound at the core portion. One or both of the primary-side winding and the secondary-side winding are divided into a plurality of division windings, and each of the plurality of the division windings of the at least one divided winding has a wound part wound at the core portion, and two extending members extending from both ends of the wound part. The extending members of the plurality of the division windings of the at least one divided winding are mutually connected, and a number of turns in the transformer of the at least one divided winding is set.

### BACKCRCUND OF THE INVENTION

### 1. Field of the Invention

The present, disclosure relates to the field of a transformer, a power conversion device, a product group of the transformer, and a manufacturing method for the transformer.

### 2. Description of the Background Art

Due to environmental regulations and technological advancement related to automobiles in recent years, electric vehicles or hybrid vehicles in various vehicle classes are developed and prevailing. A plurality of power conversion devices are mounted on a motorized vehicle in which a motor is used as a drive source, as in a hybrid vehicle or an electric vehicle. A power conversion device is a device that converts input current from DC to AC and from AC to DC, or converts input voltage to a different voltage. Specific examples of the power conversion device mounted on a motorized vehicle include a charger which converts commercial AC power to DC power to charge a high-voltage battery, a DC/DC converter which converts DC power of a high-voltage battery to DC power having different voltage, and an inverter which converts DC power from a high-voltage battery to AC power for a motor.

A DC/DC converter is mounted on a motorized vehicle in order to perform charging from a high-voltage lithium ion battery to a low-voltage lead battery, for example. In order to protect the surroundings from high voltage, the high-voltage lithium ion battery is insulated from a chassis and a low-voltage system. In a case of a DC/DC converter as well, insulation needs r.o be provided by, in general, a transformer, between the input side of high voltage and the output side of low voltage.

A transformer has a core for forming a magnetic circuit, a high-voltage primary-side winding, and a low-voltage secondary-side winding. For example, a planar-type transformer has been disclosed (see Patent Document 1, for example). In the case of the planar type, a primary-side winding and a secondary-side winding are coaxially stacked. In the case of a center-tap-type transformer, a primary-side winding is disposed between two secondary side windings. The primary-side winding has a greater number of turns than the secondary-side winding. Therefore, using a terminal of the primary-side winding as a start point, the primary-side winding is wound by several turns from the outer periphery toward the inner periphery to be connected to a primary-side winding of a different layer, and then wound by several turns from the inner periphery toward the outer periphery, and the other terminal is used as an end point. The windings of different layers are connected to each other by welding, crimping, screwing, or the like.

Patent Document 1: Japanese Laid-Open Patent Publication No. 2016-112130

Due to prevalence of motorized vehicles these days, motorization is applied in various vehicle classes. According to the vehicle classes, the capacity of a high-voltage lithium ion battery is different, and thus, voltage thereof is also different. Therefore, a DC/DC converter needs to cope with various input voltage specifications. Meanwhile, lead battery voltage, which is low, is constant irrespective of the vehicle class. Therefore, it is necessary to cope with input voltage specifications, on the basis of the number of turns of the transformer. However, the transformer structure of Patent Document 1 above has a problem that the transformer cannot easily cope with various input voltage specifications. For example, when input voltage has changed, input current also changes, and thus, it is necessary to perform thermal design such that, the heat generation amount due to increase in input current allows the transformer to be operable, in addition to change of the number of turns. This requires redesigning of the number of layers of the primary side winding, the number of turns of each layer, the line width, the connection point of each layer, and the like. In addition, it is necessary to manufacture a different transformer for each specification of input voltage. Thus, in the manufacturing process, various kinds of transformers need to be managed, and thus, there is a problem that production management, inventory management, and the like are complicated.

### SUMMARY OF THE INVENTION

Therefore, an object of the present disclosure is to provide a transformer, a power conversion device, a product group of the transformer, and a manufacturing method for the transformer that can easily cope with various input voltage specifications and that have improved productivity.

A transformer according to the present disclosure includes: a core portion for forming a magnetic circuit; and a primary-side winding and a secondary-side winding wound at the core portion. One or both of the primary-side winding and the secondary-side winding are divided into a plurality of division windings, and each of the plurality of the division windings of the at least one divided winding has a wound part wound at the core portion, and two extending members extending from both ends of the wound part. The extending members of the plurality of the division windings of the at least one divided winding are mutually connected, and a number of turns in the transformer of the at least one divided winding is set.

According to the transformer disclosed in the present disclosure, one or both of the primary-side winding and the secondary-side winding are divided into a plurality of division windings, and each of the plurality of the division windings of the at least one divided winding has a wound part wound at the core portion, and two extending members extending from both ends of the wound part; and the extending members of the plurality of the division windings of the at least one divided winding are mutually connected, and a number of turns in the transformer of the at least one divided winding is set. Therefore, series connection and parallel connection of the division windings can be switched by connection of extending members, and the number of turns of the transformer can be changed while the core portion and the wound parts of the transformer are used in common without being changed. Therefore, it is possible to obtain a transformer in which increase in the number of designing steps when the number of turns has been changed and in the kinds of the transformer due to dedicated design is suppressed, that can easily cope with various input voltage specifications, and that, has improved productivity.

### BRIEF DESCRIPTION OF THE DRAWINGS

FIG. 1 shows a circuit configuration of a power conversion device according to a first embodiment;

FIG. 2 is a table showing voltage of the power conversion device and the number of turns of a primary-aide winding according to the first, embodiment;

FIG. 3 is a schematic exploded perspective view of a transformer of the power conversion device according to the first embodiment;

FIG. 4 schematically shows a main part of the transformer of the power conversion device according to the first embodiment;

FIG. 5 shows a circuit configuration of the transformer shown in FIG. 4;

FIG. 6 schematically shows a main part of a transformer of the power conversion device according to the first embodiment;

FIG. 7 shows a circuit configuration of the transformer shown in FIG. 6;

FIG. 8 shows a manufacturing process of a transformer of the power conversion device according to the first embodiment;

FIG. 9 schematically shows a main part of a transformer of the power conversion device according to a second embodiment; and

FIG. 10 is a schematic exploded perspective view of a transformer of the power conversion device according to a third embodiment.

### DETAILED DESCRIPTION OF THE PREFERRED EMBODIMENTS OF THE INVENTION

Hereinafter, a transformer, a power conversion device, a product group of the transformer, and a manufacturing method for the transformer according to embodiments of the present disclosure will fee described with reference to the drawings. In the drawings, the same or corresponding members and parts are denoted by the same reference characters, to give description.

### First Embodiment

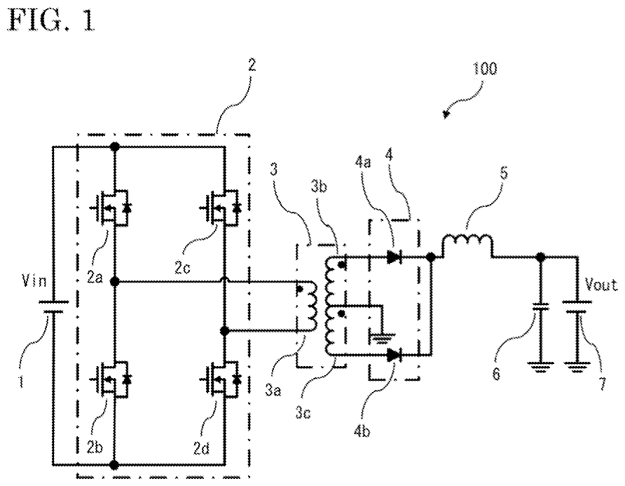

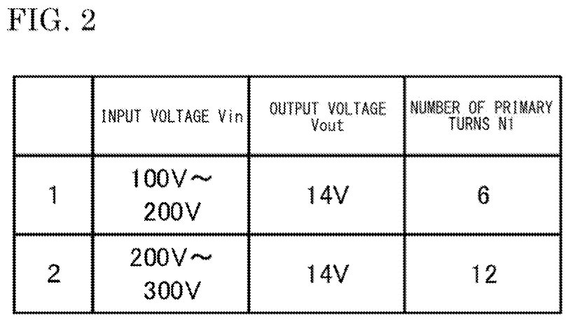

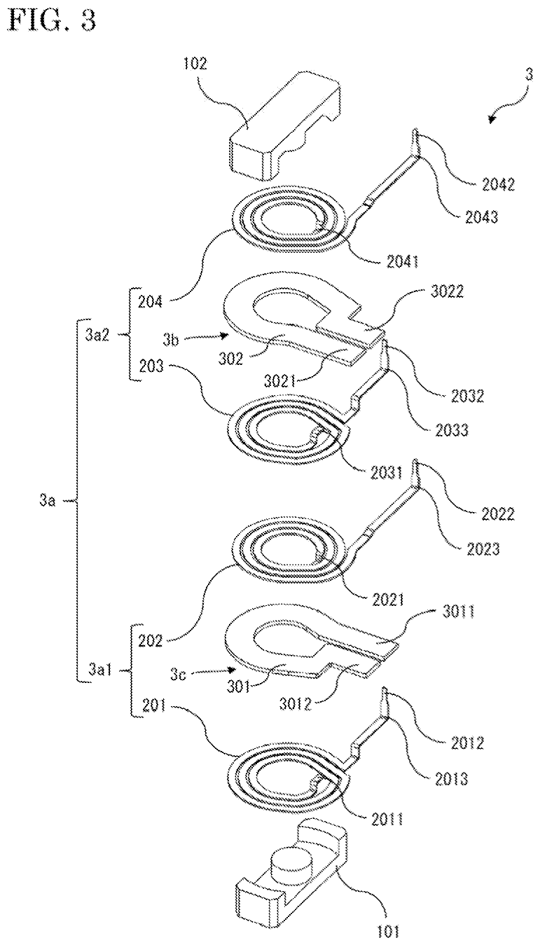

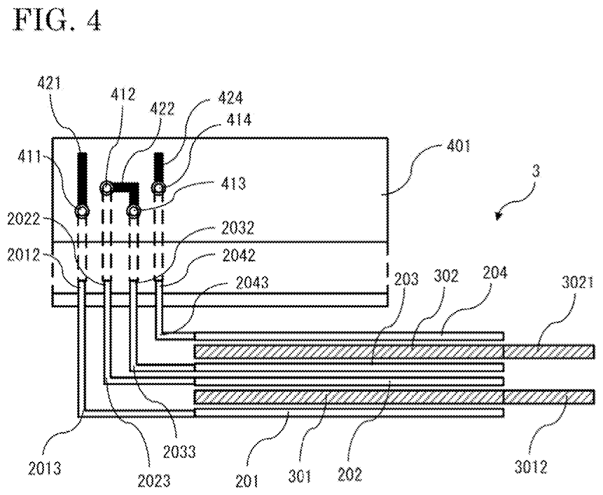

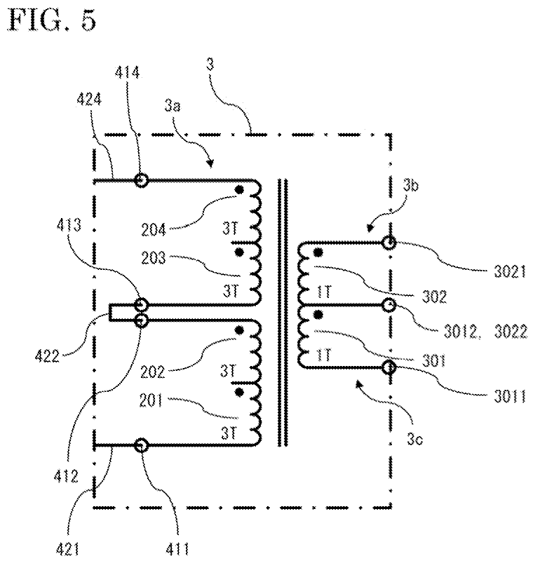

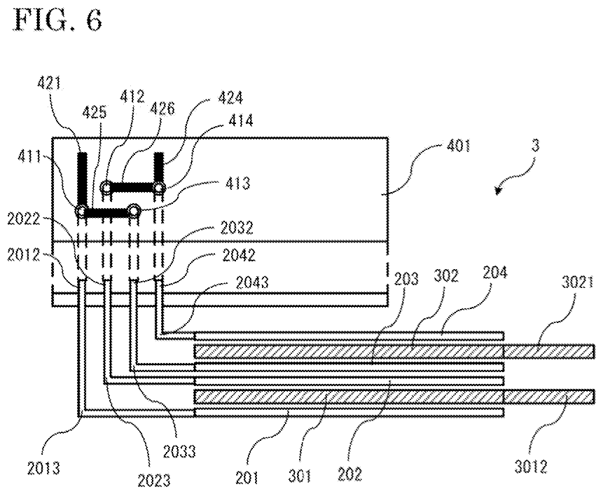

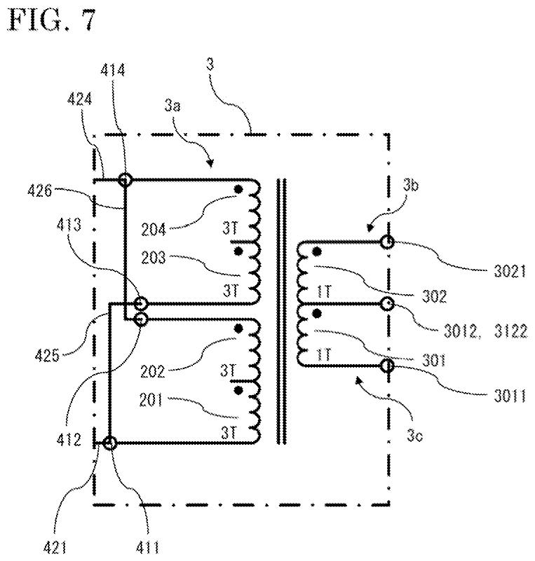

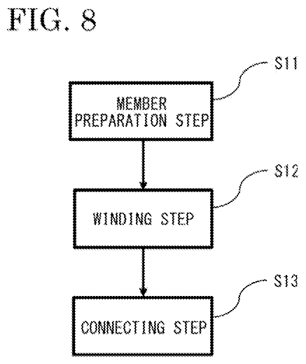

FIG. 1 shows a circuit configuration of a power conversion device 100 according to a first embodiment. FIG. 2 is a table showing voltage of the power conversion device 100 and a number of turns N1 of a primary-side winding 3a. FIG. 3 is a schematic exploded perspective view of a transformer 3 of the power conversion device 100, with a substrate 401 omitted. FIG. 4 schematically shows a main part of the transformer 3 of the power conversion device 100 viewed from a near-side left direction of the transformer 3 shown in FIG. 3, and illustrates a configuration of connection on a substrate surface of a substrate 401 shown in an upper part of the drawing. FIG. 5 shows a circuit configuration of the transformer 3 shown in FIG. 4. FIG. 6 schematically shows a main part of another transformer 3 of the power conversion device 100 according to the first embodiment, viewed from the near-side left, direction of the transformer 3 shown in FIG. 3, and illustrates a configuration of connection on a substrate surface of the substrate 402 shown in an upper part of the drawing. FIG. 7 shows a circuit configuration of the transformer 3 shown in FIG. 6. FIG. 8 shows a manufacturing process of the transformer 3 of the power conversion device 100. In FIG. 4 and FIG. 6, a lower core 101 and an upper core 102 are omitted. The power conversion device 100 is a device that converts DC voltage Vin of a DC power supply 1 to secondary-side DC voltage insulated by the transformer 3, to output DC voltage Vout to a load 7 such as a battery.

<Power Conversion Device 100>

A main circuit configuration of the power conversion device 100 is described with reference to FIG. 1. In FIG. 1, the left side is the input side, and the right side is the output side. The power conversion device 100 includes: a single-phase inverter 2 connected to the DC power supply 1 and having a plurality of semiconductor switching elements 2a, 2b, 2c, 2d which convert inputted DC voltage Vin to AC voltage and output the AC voltage; the transformer 3 which is insulated, and which converts the AC power voltage outputted from the single-phase inverter 2 and outputs the resultant voltage; and a rectification circuit 4 which rectifies output of the transformer 3. The DC power supply 1 is connected to the input side of the power conversion device 100, and the load 7 such as a low-voltage battery is connected to the output side. A reactor 5 and a smoothing capacitor 6 for smoothing the output are connected to the output side of the rectification circuit 4. The DC voltage Vout is outputted from the rectification circuit 4 to the load 7 via the reactor 5 and the smoothing capacitor 6.

The single-phase Inverter 2 has the semiconductor switching elements 2a, 2b, 2c, 2d having a full-bridge configuration. The single-phase inverter 2 is connected to the primary-side winding 3a of the transformer 3. The semiconductor switching elements 2a, 2b, 2c, 2d are each a MOSFET (Metal Oxide Semiconductor Field Effect Transistor) having a diode provided between the source and the drain, for example. The semiconductor switching element 2a, 2b, 2c, 2d is not limited to a MOSFET, and may be a self-turn-off-type semiconductor switching element such as an IGBT (Insulated Gate Bipolar Transistor) to which a diode is connected in antiparallel. The semiconductor switching element 2a, 2b, 2c, 2d is formed on a semiconductor substrate formed from a semiconductor material such as silicon (Si), silicon carbide (SiC), or gallium nitride (GaN).

The rectification circuit 4 includes diodes 4a, 4b, as rectification elements, which are semiconductor elements. The transformer 3 includes the primary-side winding 3a and secondary-side windings 3b, 3c. In the transformer 3, the secondary side is a center tap type, and the center tap terminal is connected to the GND. Secondary-side terminals other than the center tap terminal are connected to anode terminals of the diodes 4a, 4b, respectively. Cathode terminals of the diodes 4a, 4b are connected to the reactor 5. The rectification circuit 4 rectifies low AC voltage outputted from the secondary-side windings 3b, 3c, to be converted into DC pulse voltage. The reactor 5 and the smoothing capacitor 6 smooth the DC pulse voltage.

As an example of the power conversion device 100, a DC/DC converter in which the secondary side is of a center tap type has been shown. However, the secondary side may have a full-bridge configuration. In addition, although a DC/DC converter in which the primary side is of a full-bridge type has been shown, another type may be adopted as long as the converter is an insulation-type converter having an insulated transformer, such as being of a forward type, a full type, or an LLC type.

<Winding Ratio and Heat Generation of Transformer 3>

Next, the reason why the winding ratio of the transformer 3 needs to be changed due to specifications of the input/output voltage is described using an example case where specifications of input voltage are changed, when the number of turns of the primary-side winding 3a of the transformer 3 is defined as N1, and the number of turns of the secondary side winding 3b, 3c is defined as N2, a turn ratio N is represented by expression (1).

$$[ Mathematical 1 ]$$

$$N = \frac{N 2}{N 1} \qquad ( 1 )$$

When the input voltage is defined as Vin, the output voltage is defined as Vout, and the duty of the semiconductor switching element 2a, 2b, 2c, 2d is defined as D, the turn ratio is represented by expression (2).

$$[ Mathematical 2 ]$$

$$N > \frac{V out}{V in \cdot D} \qquad ( 2 )$$

In expression (2), the turn ratio N and the duty D allow degree of freedom of selection. In general, in a case where output voltage and output current to the load 7 of a DC/DC converter are constant, when the duty D is decreased and the turn ratio N is increased, the peak value of the current waveform in a rectangular wave shape of the semiconductor switching element 2a, 2b, 2c, 2d and the primary-side winding 3a of the transformer 3 is increased accordingly, and the effective value is increased. Therefore, in order to suppress .loss of the DC/DC converter, the duty D is set to a maximum possible value, and the turn ratio N of the transformer 3 is set to be small, in general.

An example of a turn ratio N that is specifically required is described with reference to FIG. 2. For simplification, the power conversion device 100 is assumed to be a step-down-type DC/DC converter, and the number of turns of the secondary-side winding 3b, 3c is defined as N2=1. The specifications of first input/output voltage are defined such that input voltage is 100 V to 200 V and output voltage is 14 V, and the specifications of second input/output voltage are defined such that input voltage is 200 V to 300 V and output voltage is 14 V. In the single phase inverter 2, a period in which the semiconductor switching elements 2a, 2d are on and the semiconductor switching elements 2b, 2c are off, and a period in which the semiconductor switching elements 2a, 2d are off and the semiconductor switching elements 2b, 2c are on are set to be substantially the same with each other, and these periods are alternately repeated. However, in order to prevent arm short-circuit, it is necessary to provide a dead time period in which all of the semiconductor switching elements 2a, 2b, 2c, 2d are off. Therefore, the maximum possible duty D is assumed to be 0.9. The turn ratio N needs to be set such that determined output voltage can be outputted at a minimum value in the range of input voltage. On the condition described above, when the number of primary turns N1 of the primary-side winding 3a of the transformer 3 is calculated using expression (2), the number of primary turns N1 needs to be 6 in the case of the specification of the first input/output voltage, and the number of primary turns N1 needs to be 12 in the case of the specification of the second input/output voltage, as shown in FIG. 2. That is, the number of primary turns N1 needs to be changed in accordance with the range of the specification of the input voltage. In addition, current becomes small in the primary-side winding 3a in which the number of turns is large.

Next, influence on the transformer 3 caused by change in the magnitude of current due to difference in the specification of input voltage is described. When the effective value of input current from the DC power supply 1 to the DC/DC converter is defined as Iin, and output current from the DC/DC converter to the load 7 is defined as Iout, the effective value of the input current is represented by expression (3).

$$[ Mathematical 3 ]$$

$$Iin = \frac{V out \cdot Iout}{V in} \qquad ( 3 )$$

Here, for simplification, efficiency of the DC/DC converter is assumed to be 1. In a case where output power (=Vout×Iout) is constant, when input voltage decreases, input current Increases in inverse proportion. Input current becomes maximum when input voltage is lowest in the range of the input voltage specification. Therefore, in the case of the specification of the first input/output voltage described above, the lower limit of the range of the input voltage is 100 V, and in the case of the specification of the second input/output, voltage, the lower limit of the range of the input voltage is 200 V. With reference to Expression (3), the input current according to the specification of the first input/output voltage flows in an amount two times the input current according to the specification of the second input/output voltage. Therefore, as the transformer 3, when the number of primary turns N1 is changed from 12 to 6 in a case where the specification of the second input/output voltage is changed to the specification of the first input/output voltage, the amount of the current that flows in the primary-side winding 3a is doubled. Therefore, due to winding loss caused by the doubled amount of current, it is necessary to change the winding cross-sectional area of the primary-side winding 3a such that the hear, generation amount of the primary-side winding 3a of the transformer 3 is in a range that allows the transformer to be operable. That is, in accordance with the range of the specification of input voltage, not only the number of primary turns N1 needs to be changed, but also designing to cope with increase in the current of the primary-side winding 3a due to the change of the number of primary turns N1 needs to be performed.

<Configuration of Transformer 3>

Here, a configuration of the transformer 3 is described using an example in which the number of turns N2 of the secondary-side winding 3b, 3c is N2=1, and the number of turns N1 of the primary-side winding 3a is N1=6 or N1=12. An example in which the number of turns HI of the primary-side winding 3a is N1=12 is described with reference to FIG. 4 and FIG. 5. An example in which the number of turns N1 of the primary-side winding 3a is N1=6 is described with reference to FIG. 6 and FIG. 7. In the present embodiment, an example of the transformer 3 having a planar 3hape in which sheet metals are stacked as shown in FIG. 3 is described. However, the configuration according to the present disclosure is not limited to a transformer having a planar shape. The transformer 3 includes: a core portion for forming a magnetic circuit; the primary-side winding 3a and the secondary-side windings 3b, 3c wound at the core portion; and a substrate 401 being a connection member. The connection member is not limited to the substrate 401, and may be another member as long as the member has wiring for connecting end portions of the windings.

The core portion includes: an outer peripheral core having an annular shape; and a center core having a columnar shape and connecting two parts opposed to each other in the outer peripheral core, and the primary-side winding 3a and the secondary-side windings 3b, 3c are wound around the center core. With this configuration, the primary-side winding 3a and the secondary-side windings 3b, 3c can be efficiently wound at the core portion having a closed magnetic path structure. The core portion i3 made from a magnetic material such as ferrite. In the present embodiment, as shown in FIG. 3, the core portion includes a lower core 101 and an upper core 102. The lower core 101 and the upper core 102 each formed in an E shape are stacked with each other, whereby the core portion having a closed magnetic path structure is formed. The core portion need not necessarily be composed of the lower core 101 and the upper core 102 each formed in an E shape, and may be composed of two division cores formed in an E shape and an I shape.

As shown in FIG. 4 and FIG. 6, the substrate 401 Is disposed in art upper direction with respect to the transformer 3. However, the disposition of the substrate 401 is not limited thereto, and the substrate 401 may be disposed in a lateral direction with respect to the transformer 3. The substrate 401 is a glass epoxy substrate, for example. The substrate 401 has mounted thereon a part of the DC/DC converter of the present embodiment, specifically, wiring for connecting components shown in FIG. 1, a driver for driving the gate of the semiconductor switching element 2a, 2b, 2c, 2d, and a control circuit for an input/output voltage sensor, etc., for controlling the DC/DC converter.

One or both of the primary-side winding and the secondary-side winding are divided into a plurality of division windings. Each of the plurality of division windings of the at least one divided winding has: a wound part wound at the core portion; and two extending members extending from both ends of the wound part. The substrate 401 mutually connects the extending members of the plurality of division windings of the at least one divided winding, and sets the number of turns in the transformer of the at least one divided winding, by a connection pattern provided to the substrate 401. With this configuration, without changing the configurations of the primary-side winding and the secondary-side winding, the number of turns in the transformer is set at the substrate 401. Therefore, a transformer that can easily cope with various input voltage specifications and that has improved productivity can be easily obtained. In the following, details of the configuration are described.

The primary-side winding 3a and the secondary-side windings 3b, 3c are formed by a plurality of winding members. Each of the plurality of winding members is formed in a shape of a plate that is curved on the same plane orthogonal to the extending direction of the center core being the part, of the core portion, around which the windings are wound, and each surface of the plate is orthogonal to the extending direction of the center core. The plurality of winding members are stacked in the extending direction of the center core. In the present embodiment, the winding members of the primary-side winding 3a and the secondary-side windings 3b, 3c are stacked, from the lower side of FIG. 3, in the order of a primary-side winding 201, a secondary-side winding 301, a primary-side winding 202, a primary-side winding 203, a secondary-side winding 302, and a primary-side winding 204. A resin member for insulation is inserted between windings, but is not shown in the drawings. In the present embodiment, the primary-side winding 3a is the plurality of division windings of the at. least one divided winding. A division winding 3a1 is formed by the primary-side winding 201 and the primary-side winding 202, and a division winding 3a2 is formed by the primary-side winding 203 and the primary-side winding 204.

A winding, out of the primary-side winding and the secondary-side winding, in which at least current that flows in the wound part is smaller is a plurality of division windings of the at least one divided winding. In the present embodiment, the primary-side winding 3a is the winding in which current that flows in the wound part is smaller, and is the plurality of division windings. With this configuration, heat generation occurring in the transformer 3 can be suppressed.

The division windings 3a1, 3a2 have the same number of winding turns and the same winding direction with each other, and the substrate 401 mutually connects the extending members of the division windings 3a1, 3a2 in series or in parallel. In FIG. 4, the division windings 3a1, 3a2 are connected in series. In FIG. 6, the division windings 3a1, 3a2 are connected in parallel. With this configuration, without changing the configurations of the primary-side winding 3a and the secondary-side windings 3b, 3c, the number of turns in the transformer can be easily set so as to suit series connection or parallel, connection by merely changing the connection pattern at the substrate 401. In addition, since the connection member is formed by the substrate 401, change between the aeries connection and the parallel connection of the plurality of division windings can be easily performed by merely changing the wiring pattern at the substrate. In the present embodiment, the connection of the extending members is performed by means of the substrate 401, but the present disclosure is not limited thereto. The connection of the extending members may be performed by welding, for example. When the connection of the extending members is performed by means of the substrate 401, the connection of the extending members can be easily switched.

The division windings 3a1, 3a2 are each formed by two additional division windings being further divisions thereof. The two additional division windings are disposed at positions different, from each other in the extending direction of the part, of the core portion, around which the windings are wound. The primary-aide windings 201, 202 forming the division winding 3a1 are the additional division windings, and the primary-side windings 203, 204 forming the division winding 3a2 are the additional division windings. With this configuration, the additional division windings can be provided so as to be stacked, and thus, the transformer 3 can be downsized.

Each of the two additional division windings has a plural number of winding turns, and is formed in a shape of a plate that is curved, on the same plane orthogonal to the extending direction of the center core, in a spiral shape around the center core, and each surface of the plate is orthogonal to the extending direction of the center core. Inner-side end portions, which are end portions on the sides closer to the core portion, of the two additional division windings are mutually connected. The two extending members extend from end portions on the sides farther from the core portion of the two additional division windings. In the present embodiment, the primary-side winding 201 is wound by three turns, and has an inner-side end portion 2011 having a bent structure toward the direction of the primary-side winding 202. The primary-side winding 202 is wound by three turns, and has an inner-side end portion 2021 having a bent structure toward the direction of the primary-side winding 201. The inner-side end portion 2011 and the inner-side end portion 2021 are disposed on the center core side with respect to the inner-side part in the winding direction of the secondary-side winding 301, and are connected to each other by welding, for example. The primary-side winding 203 is wound by three turns, and has an inner-side end portion 2031 having a bent structure toward the direction of the primary-side winding 204. The primary-side winding 204 is wound by three turns, and has an inner-side end portion 2041 having a bent structure toward the direction of the primary-side winding 203. The inner-side end portion 2031 and the inner-side end portion 2041 are disposed on the center core side with respect to the inner-side part in the winding direction of the secondary side winding 302, and are connected to each other by welding, for example.

With this configuration, the extending members extending to the outer side with respect to the wound part of. each of the primary-side windings 201, 202, 203, 204 can be reduced. Since the extending members can be reduced, the configuration of the extending members can be simplified. Since the inner-side end portions 2011, 2021, 2031, 2041 are disposed on the center core side, it is not necessary to provide layers that cross the primary-side winding 201, 202, 203, 204 and the secondary-side winding 301, 302 in order to draw end portions of the windings. Therefore, the length in the extending direction of the center core in the transformer 3 can be reduced, and thus, the transformer 3 can be downsized.

The two additional division windings are each the winding, out of the primary-side winding and the secondary-side winding, in which at least current that flows in the wound part is smaller. Between the additional division windings, the winding, out of the primary-side winding and the secondary-side winding, in which at least current that flows in the wound part is larger is disposed. In the present embodiment, the secondary-aide winding 301 is disposed between the primary side windings 201, 202 being the two additional division windings, and the secondary-side winding 302 is disposed between the primary-side windings 203, 204 being the two additional division windings. With this configuration, even when the difference in the turn ratio between the primary-side winding 3a and the secondary-side winding 3b, 3c of the transformer 3 is large, the primary-side winding 201, 202, 203, 204 and the secondary-side winding 301, 302 can be disposed so as to be close to each other, and the coupling degree of the transformer 3 can be increased. Since the coupling degree of the transformer 3 is increased, AC loss in the primary-side winding 3a and the secondary-side winding 3b, 3c can be suppressed. When the primary-side winding 201, the secondary-side winding 301, and the primary-side winding 202 are considered as one set formed in the extending direction of the center core, members can be used in common for another set, composed of the primary-side winding 203, the secondary-side winding 302, and the primary-side winding 204, which has the same configuration.

With respect to the disposition of the primary-side winding and the secondary-side winding, an example in which the additional division windings are provided has been described. However, the disposition of the primary-side winding and the secondary-side winding is not limited to that in which the additional division windings are provided. The winding, out of the primary-Side winding and the secondary-side winding, in which at least current that flows in the wound part is smaller is the plurality of division windings of the at least one divided winding, and the respective division windings being at least two divisions may be disposed, when viewed in the extending direction of the center core, on one side and the other aide of the winding in which the current that flows in the wound part is larger. For example, two division windings of the primary-side winding may be disposed on both sides of one secondary-side winding. With this configuration, even when the difference in the turn ratio between the primary-side winding and the secondary-side winding of the transformer 3 is large, the two division windings of the primary-side winding and the secondary-side winding can be disposed so as to be close to each other, whereby the coupling degree of the transformer 3 can be increased. Since the coupling degree of the transformer 3 is increased, AC loss in the primary-side winding and the secondary-side winding can be suppressed.

The winding, out of the primary-side winding and the secondary-side winding, in which at least current that flows in the wound part is smaller is the plurality of division windings of the at least one divided winding, and each of the plurality of division windings has a plural number of winding turns, in at least one layer. In the present embodiment, primary described above, the number of winding turns of the primary-side winding 201, 202, 203, 204 being each of the division windings is three. With this configuration, even when the difference in the turn ratio between the primary-side winding 3a and the secondary-side winding 3b, 3c of the transformer 3 is large, the primary-side winding 201, 202, 203, 204 and the secondary-side winding 301, 302 can be disposed so as to be close to each other, whereby the coupling degree of the transformer 3 can be increased. Since the coupling degree of the transformer 3 is increased, AC loss in the primary-side winding 3a and the secondary-side winding 3b, 3c can be suppressed. In addition, since the number of layers of the primary-side winding and the secondary-side winding can be reduced, in a case where the transformer 3 is to be cooled, coolability of the primary-side winding and the secondary-side winding can be improved. Since the coolability of the primary-side winding and the secondary-side winding is improved, the transformer 3 can be downsized.

The order of stacking the plurality of winding members of the primary-side winding and the secondary-side winding is in symmetry with respect to the center in the direction of the stacking. With this configuration, a plurality of winding members provided on one side with respect to the center in the direction of the stacking and a plurality of winding members provided on the other side can respectively be considered as sets having the same configuration. In the present embodiment, the set of the primary-side winding 201, the secondary-side winding 301, and the primary-side winding 202 is a set on one side, and the set of the primary-side winding 203, the secondary side winding 302, and the primary-side winding 204 is a set on the other side. Since the configurations of both sets are the same, members for both sets can be used in common. Since members for both sets can be used in common, productivity of the transformer 3 can be improved.

End portions of the two extending members of the division winding 3a1 are connection terminals 2012, 2022. End portions of the two extending members of the division winding 3a2 are connection terminals 2032, 2042. The extending members respectively have bent portions 2013, 2023, 2033, 2043 bent in the direction of the substrate 401. The secondary-aide winding 301 is wound by one turn around the center core and has terminals 3011, 3012 to be connected to the outside. The secondary-side winding 302 is wound by one turn around the center core and has terminals 3021, 3022 to be connected to the outside.

The connection terminals 2012, 2022, 2032, 2042 being the end portions of the respective extending members of the division windings 3a1, 3a2 have the same shape. When the shape is the same, connection to the substrate 401 can be easily performed. Even in a case where the number of winding turns of the division windings 3a1, 3a2 is changed and the division windings 3a1, 3a2 are replaced by division windings of other members, if the shape of the connection terminals are the same, connection to the substrate 401 can be easily performed as before the replacement was performed.

A connection side in which the number of turns N1 of the primary-side winding 3a is N1=12 is described. The number of wincing turns of the primary-side windings 201, 202, 203, 204 is three, the division winding 3a1 is configured by the primary-side windings 202, 202 being connected in series, and the division winding 3a2 is configured by the primary-side windings 203, 204 being connected in series. The division windings 3a1, 3a2 each have six turns. As shown in FIG. 4, the connection terminals 2012, 2022, 2032, 2042 are respectively passed through through-holes 411, 412, 413, 414 provided in the substrate 401, and are soldered. Each of the through-holes 411, 412, 413, 414 is connected on the substrate 401 by a substrate wiring being a connection pattern. The through-hole 411 has a substrate wiring 421 connected thereto, the through-hole 412 has the through-hole 413 connected thereto via a substrate wiring 422, and the through-hole 414 has a substrate wiring 424 connected thereto. Since the division windings 3a1, 3a2 are connected in series at the substrate 401 in this manner, the number of turns N1 of the primary-side winding 3a becomes 12.

In the example shown in FIG. 4, the through-holes 411, 412, 413, 414 provided in the substrate 401 are disposed so as not to be arranged on one straight line, such that the configuration in which the connection terminals 2012, 2022, 2032, 2042 extending from the primary-side windings 201, 202, 203, 204 of the transformer 3 are connected at the substrate 401 can be easily understood when viewed from the direction in which the stacked structure of the primary-side windings 201, 202, 203, 204 are seen. However, the disposition of the through-holes 411, 412, 413, 414 is not limited thereto. The connection terminals 2012, 2022, 2032, 2042 may be caused to extend from the primary-side windings 201, 202, 203, 204 such that the through-holes 411, 412, 413, 414 are at corner positions of a rectangle in a top view of the substrate 401. Alternatively, the connection terminals 2012, 2022, 2032, 2042 may be caused to extend from the primary side windings 201, 202, 203, 204 such that the through-holes 411, 412, 413, 414 are arranged on one straight line.

With reference to FIG. 5, a configuration of connection of the primary-side winding 3a and the secondary-side windings 3b, 3c is described. The primary-side windings 201, 202 are connected in series, the primary-side windings 203, 204 are connected in series, and the primary-side windings 202, 203 are connected by the substrate wiring 422 via the through-holes 412, 413 of the substrate 401, respectively. The primary-side windings 201, 204 are respectively connected by the substrate wirings 421, 424 via the through-holes 411, 414 of the substrate 401, and are connected to the single-phase inverter 2 shown in FIG. 1. The terminals 3022, 3012 of the secondary-side windings 302, 301 each have a bent structure toward the direction in which the terminals 3022, 3012 are in contact with each other, for example. In the place where the terminals 3022, 3012 are in contact with each other, the terminals 3022, 3012 are connected to each other by a screw, welding, or the like, to serve as a center tap terminal on the secondary side. The terminals 3021, 3011 of the secondary-side windings 302, 301 are connected to the rectification circuit 4 shown in FIG. 1, and the terminals 3012, 3022 are connected to the GND shown in FIG. 1. The circuit surrounded by an alternate long and short dash line of the transformer 3 shown in FIG. 1 corresponds to the circuit surrounded by an alternate long and short dash line of the transformer 3 shown in FIG. 5.

As shown in, FIG. 4, the substrate 401 is disposed so as to overlap the extending members, when viewed in the extending direction of the center core. When viewed in the extending direction of the center core, each of the extending members provided, so as to overlap, of each of the plurality of division windings 3a1, 3a2 is provided with a bent portion at a different position. In the present embodiment, when viewed in the extending direction of the center core, the extending members of the primary-side windings 201, 203 are provided so as to overlap each other, and the extending members of the primary-side windings 202, 204 are provided so as to overlap each other. Therefore, the bent portions 2013, 2033 are provided at different positions, and the bent portions 2023, 2043 are provided at different positions. With this configuration, when the primary-side windings 201, 202, 203, 204 are manufactured so as to have the same shape, and the positions of the bent portions 2013, 2023, 2033, 2043 are changed, winding members can be used in common. Since the winding members can be used in common, production management during manufacture of the transformer 3 and inventory management thereof are facilitated. Therefore, productivity of the transformer 3 can be improved.

The substrate 401 is disposed on one side or the other side with respect to the primary-side winding 3a and the secondary-side windings 3b, 3c, when viewed in the extending direction of the center core. With this configuration, the bending directions of the bent portions 2013, 2023, 2033, 2043 can be made uniform, and the substrate 401 can be implemented from the extending direction of the center core after the primary-side winding 3a and the secondary-side windings 3b, 3c have been provided. Therefore, ease of assembly of the transformer 3 is improved, and thus, productivity of the transformer 3 can be improved.

A connection configuration in which the number of turns N1 of the primary-side winding 3a is N1=6 is described. The number of winding turns of the primary-side windings 201, 202, 203, 204 is three, the division winding 3a1 is configured by the primary-side windings 201, 202 being connected in series, and the division winding 3a2 is configured by the primary-side windings 203, 204 being connected in series. The division windings 3a1, 3a2 each have six turns. As shown in FIG. 6, the connection terminals 2012, 2022, 2032, 2042 are respectively passed through the through holes 411, 412, 413, 414 provided in the substrate 401, and are soldered. Each of the through-holes 411, 412, 413, 414 is connected on the substrate 401 by a substrate wiring being a connection pattern. The connection terminal 2012 and the connection terminal 2032 are connected by a substrate wiring 425 via the through-holes 411, 413, respectively. The connection terminal 2022 and the connection terminal 2042 are connected by a substrate wiring 426 via the through-holes 412, 414, respectively. The through-holes 411, 414 have the substrate wirings 421, 424 connected thereto, respectively. Since the division windings 3a1, 3a2 are connected in parallel at the substrate 401 in this manner, the number of turns N1 of the primary-side winding 3a becomes six.

With reference to FIG. 7, a configuration of connection of the primary-side winding 3a and the secondary-side windings 3b, 3c is described. The primary-side windings 201, 202 are connected in series, and both ends thereof are connected to the through-holes 411, 412, respectively. The primary-side windings 203, 204 are connected in series, and both ends thereof are connected to the through-holes 413, 414, respectively. The through-hole 411 and the through-hole 413, and the through-hole 412 and the through-hole 414 are connected by the substrate wirings 425, 426, respectively, whereby the primary side windings 201, 202 connected in series and the primary-side windings 203, 204 connected in series are connected in parallel.

In the configuration of the parallel connection described above, each of the division windings 3a1, 3a2 has the same number of turns and the same winding direction, the division windings 3a1, 3a2 are disposed at different positions from each other in the extending direction of the center core, the connection terminals 2012, 2032 on the winding start, side of the respective division windings 3a1, 3a2 are electrically connected at the substrate 401, and the connection terminals 2022, 2042 on the winding end side of the respective division windings 3a1, 3a2 are electrically connected at the substrate 401. In an application in which the number of primary turns N1 of the transformer 3 is relatively large, in order to make the projected area small so as to prevent increase in size of the planar-type transformer, the number of turns per layer has to be reduced, and the number of layers has to be increased. In such a case, as to which layer's windings are to be connected in parallel, a degree of freedom is generated. With this configuration, connection inside the transformer is facilitated, and the number of connection terminals to be drawn for performing connection at the substrate 401 can be reduced, and the drawing structure can be simplified. In addition, windings can be used in common as the primary side windings 201, 202 on the lower side with respect to the center in the direction of the stacking and as the primary-side windings 203, 204 on the upper side with respect to the center in the direction of the stacking.

When compared with the transformer 3 in which the number of turns NI of the primary-side winding 3a is 12, the number of turns of the primary-side winding 3a is halved, and thus, current in a doubled amount flows in the primary-side winding 3a. However, since the primary-side winding 3a is realized by parallel connection of the primary-side windings 201, 202 and the primary-side windings 203, 204, current that flows in each of the primary-side windings 201, 202, 203, 204 becomes the same as that when the number of turns N1 is 12. That is, even when current that flows on the primary side of the transformer 3 has been changed due to change in the number of turns N1, current that flows in each of the primary-side windings 201, 202, 203, 204 is the same. Therefore, it is not necessary to perform redesigning, such as changing the winding width or reconsidering the cooling method, in order to cause the heat generation amount of the primary-side winding 3a to be in a range that allows the transformer to be operable. This is particularly effective when the cooling conditions of the primary side windings 201, 202, 203, 204 are substantially the same, such as when natural heat dissipation is allowed, the primary-side windings 201, 204 are cooled from both surfaces thereof, and the terminals 3011, 3012, 3021, 3022 of the secondary side windings 301, 302 are cooled.

When the transformer 3 shown in the present embodiment is used in the power conversion device 100, a power conversion device that can easily cope with various input voltage specifications and that has improved productivity can be obtained. In addition, when the transformer 3 shown in the present embodiment is used in the power conversion device 100, a part of circuits forming the power conversion device 100 may be mounted on the substrate 401. With this configuration, connection of the connection terminals 2012, 2022, 2032, 2042 of the primary-side winding of the transformer 3 is changed at the substrate 401 on which a part of the circuits of the power conversion device 100 is mounted. Therefore, there is no need to provide a dedicated member for changing the connection, and thus, the power conversion device 100 can be downsized and the power conversion device 100 can be produced at low cost.

As described above, since series connection and parallel connection of the division windings 3a1, 3a2 are switched at the substrate 401, the number of turns N1 of the primary-side winding 3a can be switched between 6 and 12 while the core portion and the winding members of the transformer 3 are used in common without being changed. Accordingly, since various input voltage specifications can be easily coped with, there is no need to redesign the core portion and the winding members of the transformer 3, and thus, the same kinds of the materials forming the transformer 3 can be used in common. Since the same kinds of the materials forming the transformer 3 are used in common, increase in the number of designing steps when the number of turns has been changed and in the kinds of the transformer 3 due to dedicated design is suppressed, and production management during manufacture of the transformer 3 and inventory management thereof are facilitated. Therefore, productivity of the transformer 3 can be improved.

In the present embodiment, the transformer 3 is a planar-type transformer. Since from which of the primary-side windings 201, 202, 203, 204 the connection terminals of the extending members to be connected by the connection member such as the substrate 401 are drawn, can be selected, the primary-side windings 201, 202, 203, 204, the secondary-side windings 301, 302, and the core portion can be easily used in common by merely changing the connection terminals. Therefore, productivity of the transformer 3 can be improved.

<Product Group of Transformer 3>

A product group of the transformer 3 includes a first transformer and a second transformer. The first transformer includes: a core portion for forming a magnetic circuit; a primary-side winding and a secondary-side winding wound at the core portion; and a first connection member. One or both of the primary-side winding and the secondary-side winding are divided into a plurality of division windings. Each of the plurality of division windings of the at least one divided winding has: a wound part wound at the core portion; and two extending members extending from both ends of the wound part. The first connection member mutually connects the extending members, in series, of the plurality of division windings of the at least one divided winding, and sets the number of turns in the transformer of the at least one divided winding, by a series connection pattern.

The second transformer includes: a core portion having the same configuration as that of the first transformer; a primary-side winding and a secondary-side winding having the same configurations of those of the first transformer; and a second connection member. The second connection member mutually connects the extending members, in parallel, of the plurality of division windings of the at least one divided winding, and sets the number of turns in the transformer of the at least one divided winding, by a parallel connection pattern. In the present embodiment, the transformer 3 shown in FIG. 4 is the first transformer, and the transformer 3 shown in FIC. 6 is the second transformer. The substrate 401 shown in FIG. 4 is the first connection member, and the substrate 401 shown in FIG. 6 is the second connection member.

Since the first connection member having the series connection pattern and the second connection member having the parallel connection pattern are provided, the first transformer and the second transformer having different connection configurations can be easily managed as a product group. Since production management during manufacture of the transformer 3 and inventory management thereof are facilitated, productivity of the transformer 3 can be improved.

<Manufacturing Method for Transformer 3>

A manufacturing method for the transformer 3 is described with reference to FIG. 8. The transformer 3 is manufactured through a member preparation step (S11), a winding step (S12), and a connecting step (S13). The member preparation step is a step of preparing: the lower core 101 and the upper core 102 being the core portion for forming a magnetic circuit; the primary-side winding and the secondary-side winding; and the substrate 401 being a connection member. The winding step is a step of winding the primary-side winding and the secondary-side winding at the core portion. The connecting step is a step of connecting one or both of the primary-side winding and the secondary-side winding to the substrate 401. In the following, details are described.

In the member preparation step, the primary-side winding and the secondary-side winding in which one or both of the primary-side winding and the secondary-side winding are divided into a plurality of division windings, and each of the plurality of division windings of the at least one divided winding has a wound part wound at the core portion, and two extending members extending from both ends of the wound part, are prepared as the primary-side winding and the secondary-side winding. When the transformer 3 is a planar-type transformer, the winding step is a step of disposing winding members of the primary-side winding and the secondary-side winding at the core portion.

In the connecting step, a first connecting step of mutually connecting the extending members, by the substrate 401 in series, of the plurality of division windings of the at least one divided winding, and of setting the number of turns in the transformer of the at least one divided winding, by a series connection pattern of the substrate 401; and a second connecting step of mutually connecting the extending members, by the substrate 401 in parallel, of the plurality of division windings of the at least one divided winding, and of setting the number of turns in the transformer of the at least, one divided winding, by a parallel connection pattern of the substrate 401, are executed. Through the first connecting step, the first transformer described above is made, and through the second connecting step, the second transformer described above is made.

Since the first connecting step and the second connecting step are provided, the first transformer and the second transformer having different connection configurations can be easily manufactured. Since the first transformer and the second transformer can be easily manufactured, production management during manufacture of the transformer 3 and inventory management thereof are facilitated. Therefore, productivity of the transformer 3 can be improved.

As described above, in the transformer 3 according to the first embodiment, one or both of the primary-side winding and the secondary-side winding are divided into a plurality of division windings, and each of the plurality of division windings of the at least one divided winding has a wound part wound at the core portion, and two extending members extending from both ends of the wound part, the extending members of the plurality of division windings of the at least one divided winding are mutually connected, and the number of turns in the transformer of the at least one divided winding is set. Therefore, series connection and parallel connection of the division windings can be switched in accordance with connection of the extending members, and the number of turns of the transformer can be changed while the core portion and the winding members of the transformer 3 are used in common without being changed. Therefore, since various input voltage specifications can be easily coped with, there is no need to redesign the core portion and the winding members of the transformer 3, and thus, the same kinds of the materials forming the transformer 3 can be used in common. Since the same kinds of the materials forming the transformer 3 can be used in common, increase in the number of designing steps when the number of turns has been changed and in the kinds of the transformer 3 due to dedicated design is suppressed, and production management during manufacture of the transformer 3 and inventory management thereof are facilitated. Therefore, productivity of the transformer 3 can be improved. When the substrate 401 is provided, the substrate 401 mutually connects the extending members of the plurality of division windings of the at. least one divided winding, and the number of turns in the transformer of the at least one divided winding is set by the substrate wirings, series connection and parallel connection of the division windings can be easily switched at the substrate 401.

When the winding, out. of the primary-side winding and the secondary-side winding, in which at least current that flows in the wound part is smaller is the plurality of division windings of the at least one divided winding, heat generation occurring in the transformer 3 can be suppressed. When the division windings 3a1, 3a2 have the same number of winding turns and the same winding direction with each other, and the substrate 401 mutually connects the extending members of the division windings 3a1, 3a2 in series or in parallel, the number of turns in the transformer can be easily set so as to suit series connection or parallel connection, by merely changing the substrate wirings at the substrate 401 without changing the configurations of the primary-side winding 3a and the secondary-side windings 3b, 3c.

When the primary side winding and the secondary side winding are formed by a plurality of winding members, each of the plurality of winding members is formed in a shape of a plate that is curved on the same plane orthogonal to the extending direction of the center core, each surface of the plate is orthogonal to the extending direction of the center core, and the plurality of winding members are stacked in the extending direction of the center core, since the transformer 3 is a planar-type transformer, and from which of the primary-side windings 201, 202, 203, 204 the connection terminals of the extending member to be connected by the connection member such as the substrate 401 are drawn, can be selected, the primary-side windings 201, 202, 203, 204, the secondary-side windings 301, 302, and the core portion can be easily used in common by merely changing the connection terminals. Therefore, productivity of the transformer 3 can be improved.

When the winding, out cf the primary-side winding and the secondary-side winding, in which at least current that flows in the wound part is smaller is the plurality of division windings of the at least one divided winding, and end portions of the respective extending members of the plurality of division windings have the same shape, connection to the substrate 401 can be easily performed. Even in a case where the number of winding turns of the division windings 3a1, 3a2 is changed and the division windings 3a1, 3a2 are replaced by division windings of other members, it the shape of the connection terminals are the same, connection to the substrate 401 can be easily performed as before the replacement, was performed.

When the winding, out of the primary-side winding and the secondary side winding, in which at least current that flows in the wound part is smaller is the plurality of division windings of the at least one divided winding, and each of the plurality of division windings has a plural number of winding turns, in at least one layer, even when the difference in the turn ratio between the primary-side winding 3a and the secondary-side winding 3b, 3c of the transformer 3 is large, the primary-side winding 201, 202, 203, 204 and the secondary-side winding 301, 302 can be disposed so as to be close to each other, whereby the coupling degree of the transformer 3 can be increased. Since the coupling degree of the transformer 3 is increased, AC loss in the primary-side winding 3a and the secondary-side winding 3b, 3c can be suppressed.

When the winding, out of the primary-side winding and the secondary-side winding, in which at least current that flows in the wound part is smaller is the plurality of division windings of the at least one divided winding, and the respective division windings being at least two divisions are disposed, when viewed in the extending direction of the center core, on one side and the other side of the winding in which current that flows in the wound part is larger, even when the difference in the turn ratio between the primary-side winding 3a and the secondary-side windings 3b, 3c of the transformer 3 is large, the two division windings of the primary-side winding and the secondary-side winding can be disposed so as to be close to each other, whereby the coupling degree of the transformer 3 can be increased. Since the coupling degree of the transformer 3 is increased, AC loss in the primary-side winding and the secondary-side winding can be suppressed.

When the division windings are each formed by two additional division windings being further divisions thereof, and the two additional division windings are disposed at positions different from each other in the extending direction of the center core around which the windings are wound, the additional division windings can be provided so as to be stacked, and thus, the transformer 3 can be downsized.

When each of the two additional division windings has a plural number of winding turns, and is formed in a shape of a plate that is curved, on the same plane orthogonal to the extending direction, in a spiral shape around the center of the core portion; each surface of the plate is orthogonal to the extending direction of the center core; end portions on the sides closer to the core portion of the two additional division windings are mutually connected; and the two extending members extend from end portions on the sides farther from the core portion of the two additional division windings, the extending members extending to the outer side with respect to the wound part of each of the primary-side windings 201, 202, 203, 204 can be reduced. Therefore, configuration of the extending member can be simplified. Since the inner-side end portions 2011, 2021, 2031, 2041 are disposed on the center core side, it is not necessary to provide layers that cross the primary-side winding 201, 202, 203, 204 and the secondary-side winding 301, 302 in order to draw end portions of the windings. Therefore, the length in the extending direction of the center core in the transformer 3 can be reduced, and thus, the transformer 3 can be downsized.

When the two additional division windings are each the winding, out of the primary-side winding and the secondary-side winding, in which at least current that flows in the wound part is smaller, and the winding, out of the primary-side winding and the secondary-side winding, in which at least current that flows in the wound part is larger is disposed between the two additional division windings in the extending direction, even in a case where the difference in the turn ratio between the primary-side winding 3a and the secondary-side windings 3b, 3c of the transformer 3 is large, the primary-side winding 201, 202, 203, 204 and the secondary side winding 301, 302 can be disposed so as to be close to each other. Therefore, the coupling degree of the transformer 3 can be increased. Since the coupling degree of the transformer 3 is increased, AC loss in the primary-side winding 3a and the secondary-side winding 3b, 3c can be suppressed.

When the order of stacking the plurality of winding members of the primary-side winding and the secondary-side winding is in symmetry with respect to the center in the direction of the stacking, a plurality of winding members provided on one side with respect to the center in the direction of the stacking and a plurality of winding members provided on the other side can respectively be considered as sets having the same configuration, and since the configurations of both sets are the same, members for both sets can be used in common. Since members for both sets can be used in common, productivity of the transformer 3 can be improved.

When the winding, out of the primary-side winding and the secondary-side winding, in which at least current that flows in the wound part is smaller is the plurality of division windings of the at least one divided winding, each of the plurality of division windings has the same number of turns and the same winding direction, the plurality of division windings are respectively disposed at positions different from each other in the extending direction of the part, of the core portion, around which the windings are wound, the extending member on the winding start side of each of the plurality of division windings is electrically connected at the connection member, and the extending member on the winding end side of each of the plurality of division windings is electrically connected at the connection member, connection inside the transformer is facilitated, and the number of connection terminals to be drawn for performing connection at the substrate 401 can be reduced, and the drawing structure can be simplified. In addition, windings can be used in common as the primary-side windings 201, 202 on the lower side with respect to the center in the direction of the stacking and as the primary-side windings 203, 204 on the upper side with respect to the center in the direction of the stacking.

When the connection member is a substrate, change between series connection and parallel connection of the primary-side winding 3a and the secondary-side windings 3b, 3c can be easily performed by merely changing the wiring pattern of the substrate. When the substrate is disposed so as to overlap the extending members when viewed in the extending direction of the center core around which the windings are wound, each of the extending members has a bent portion bent in the direction of the substrate, and each of the extending members provided, so as to overlap, of each of the plurality of division windings is provided with the bent portion at a different position, when viewed in the extending direction of the part, of the core portion, around which the windings are wound, the winding members can be used in common by manufacturing the primary-side windings 201, 202, 203, 204 so as to have the same shape, and by changing the positions of the bent portions 20.13, 2023, 2033, 2043. Since the winding members can be used in common, production management during manufacture of the transformer 3 and inventory management thereof are facilitated. Therefore, productivity of the transformer 3 can be improved.

When the substrate is disposed on one side or the other side with respect to the primary side winding and the secondary-side winding when viewed in the extending direction of the center core around which the windings are wound, the bending directions of the bene portions 2013, 2023, 2033, 2043 can be made uniform, and the substrate 401 can be implemented from the extending direction of the center core after the primary-side winding 3a and the secondary-side windings 3b, 3c have been provided. Therefore, ease of assembly of the transformer 3 is improved, and thus, productivity of the transformer 3 can be improved.

When the core portion includes: an outer peripheral core having an annular shape; and a center core having a columnar shape and connecting two parts opposed to each other in the outer peripheral core, and the primary-side winding and the secondary-side winding are wound around the center core, the primary-side winding 3a and the secondary-side windings 3b, 3c can be efficiently wound at the core portion having a closed magnetic path structure.

When the power conversion device 100 includes: a plurality of semiconductor switching elements 2a, 2b, 2c, 2d which are connected to a DC power supply and which convert inputted DC power to AC power and output the AC power; the transformer 3, according to the present embodiment, which converts voltage of the AC power outputted from the plurality of semiconductor switching elements 2a, 2b, 2c, 2d and outputs the resultant voltage; and the rectification circuit 4 which rectifies output of the transformer 3, the power conversion device 100 that can easily cope with various input voltage specifications, and that has improved productivity can be obtained. When the connection member is implemented by the substrate 401, and a part of circuits forming the power conversion device 100 is mounted on the substrate 401, connection of the connection terminals 2012, 2022, 2032, 2042 of the primary-side winding of the transformer 3 is changed at the substrate 401 on which a part of the circuits of the power conversion device 100 is mounted. Therefore, there is no need to provide a dedicated member for changing the connection, and thus, the power conversion device 100 can be downsized and the power conversion device 100 can be produced at low cost.

A product group of the transformer 3 includes: a first transformer in which one or both of the primary-side winding and the secondary-side winding are divided into a plurality of division windings, and each of the plurality of division windings of the at least one divided winding has a wound part wound at the core portion, and two extending members extending from both ends of the wound part, and the first connection member mutually connects the extending members, in series, of the plurality of division windings of the at least one divided winding, and sets the number of turns in the transformer of the at least one divided winding, by a series connection pattern; and a second transformer including a core portion that, has the same configuration as that of the first transformer, a primary-side winding and a secondary-side winding that have the same configurations of those of the first transformer, and a second connection member, wherein the second connection member mutually connects the extending members, in parallel, of the plurality of division windings of the at least one divided winding, and sets the number of turns in the transformer of the at least one divided winding, by a parallel connection pattern. In this case, since the first connection member having the series connection pattern and the second connection member having the parallel connection pattern are provided, the first transformer and the second transformer having different connection configurations can be easily managed as a product group. Since production management during manufacture of the transformer 3 and inventory management thereof are facilitated, productivity of the transformer 3 can be improved.

A manufacturing method for the transformer includes a member preparation step, a winding step, and a connecting step. In the member preparation step, the primary-side winding and the secondary-side winding in which one or both of the primary-side winding and the secondary-side winding are divided into a plurality of division windings, and each of the plurality of division windings of the at least one divided winding has a wound part wound at the core portion, and two extending members extending from both ends of the wound part, are prepared as the primary side winding and the secondary-side winding. In the connecting step, a first connecting step of mutually connecting the extending members, by the connection member in series, of the plurality of division windings of the at least one divided winding, and of setting a number of turns in the transformer of the at least one divided winding, by a series connection pattern of the connection member, and a second connecting step of mutually connecting the extending members, by the connection member in parallel, of the plurality of division windings of the at least, one divided winding, and of setting a number of turns in the transformer of the at least one divided winding, by a parallel connection pattern of the connection member, are executed. In this case, since the first connecting step and the second connecting step are provided, the first transformer and the second transformer having different connection configurations can foe easily manufactured. Since the first transformer and the second transformer can be easily manufactured, production management during manufacture of the transformer 3 and inventory management thereof are facilitated. Therefore, productivity of the transformer 3 can be improved.

### Second Embodiment

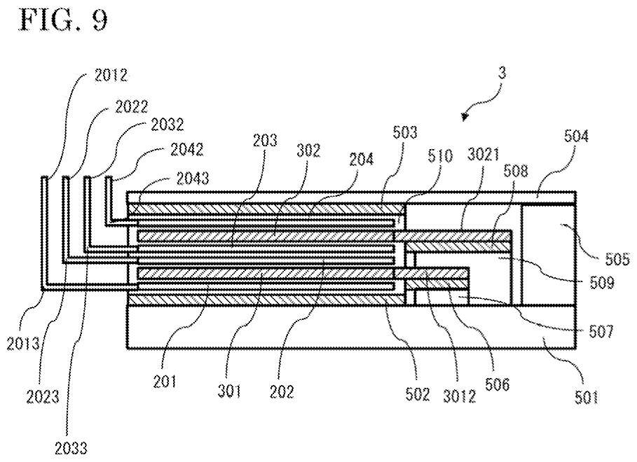

A transformer 3 according to a second embodiment is described. FIG. 9 schematically shows a main part of the transformer 3 of the power conversion device 100 according to the second embodiment, with the substrate 401 omitted. FIG. 9 shows a cross-section of a place where the core portion is not included. The transformer 3 according to the second embodiment is provided with a cooler 501 being a cooling member. In the present embodiment, the configurations of the primary-side winding and the secondary-side winding are the same as those in the first embodiment.

The transformer 3 includes the cooler 501. The cooler 501 is formed by using a cast product of metal such as an aluminum alley or a copper alloy, or a sheet, metal member, for example. The cooler 501 has a role of dissipating, to the outside, heat generated when current, flows in the transformer 3. The core portion is thermally connected to the cooler 501. With this configuration, the core portion can be efficiently cooled.

The primary-side windings 201, 202, 203, 204 and the secondary-side windings 301, 302 are molded by a resin member 510 through insert molding, for example. The primary-side winding 201 is thermally connected to the cooler 501 via the resin member 510 and a heat dissipation member 502 such as grease. The primary-side winding 204 is thermally connected to a cooling plate 504 via the resin member 510 and a heat dissipation member 503 such as grease. The cooling plate 504 is thermally connected to an extension portion 505 of the cooler 501. The cooling plate 504 and the extension portion 505 are fixed to the cooler 501 by screwing, for example. The cooling plate 504 and the extension portion 505 are made of the same material as that of the cooler 501, for example.

A winding, out of the primary-side winding and the secondary-side winding, in which at least current that flows in the wound part is smaller is the plurality of division windings of the at least one divided winding, and a division winding, out of the plurality of division windings, that has the maximum number of winding turns is disposed so as to be closest to the cooler 501. Here, the number of winding turns of all of the primary-side windings are each three, and the primary side winding 201 is disposed so as to be closest to the cooler 501. With this configuration, a winding that has a large number of turns and a large heat generation amount can be efficiently cooled.

The terminals 3011, 3012 of the secondary -side winding 301 are thermally connected to an extension portion 507 of the cooler 501 via a heat dissipation member 506 having an insulating property. The terminals 3021, 3022 of the secondary-side winding 302 are thermally connected to an extension portion 509 of the cooler 501 via a heat dissipation member 508 having an insulating property. In general, the cooler 501 often has the ground potential, and in particular, the terminals 3012, 3022 have the ground potential. Therefore, the parts of the heat dissipation members 506, 508 between the terminals 3012, 3022 and the cooler 501 may be heat dissipation members that do net have insulating properties. The extension portions 507, 509 are made of the same material as that of the cooler 501, for example.

The extension portion 505, 507, 509 from the cooler 501 may be a part of the cooler 501, or may be a separate member. Without the extension portions 505, 507, 509, the terminals 3011, 3012 of the secondary-side winding 301, the terminals 3021, 3022 of the secondary side winding 302, or the cooling plate 504 may each have a bent structure toward the direction of the cooler 501, and may be directly thermally connected to the cooler 501.

As described above, when, out of the primary-side winding and the secondary-side winding, the secondary-side windings 301, 302 each being the winding in which current that flows in the wound part is larger each have a part directly or indirectly thermally connected to the cooler 501, the winding in which current that flows in the wound part is larger can be efficiently cooled. The primary-side windings 201, 202 are cooled via the resin member 510 and the secondary-side winding 302, and the primary-side windings 203, 204 are cooled via the resin member 510 and the secondary-side winding 302. When the winding in which current that flows in the wound part is larger is the primary-side winding, a part directly or indirectly thermally connected to the cooler 501 is provided to the primary-side winding.

### Third Embodiment

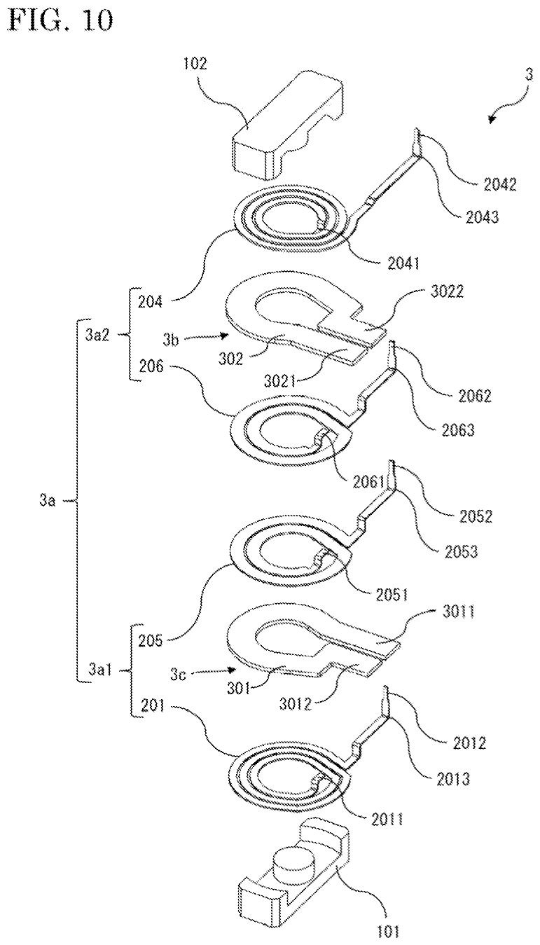

A transformer 3 according to a third embodiment is described. FIG. 10 is a schematic exploded perspective view of the transformer 3 of the power conversion device 100 according to the third embodiment, with the substrate 401 omitted. The transformer 3 according to the third embodiment is configured such that the number of winding turns of the primary-side winding 3a is different from that in the first embodiment. In the present embodiment, except for the number of winding turns of the primary-side winding 3a , the configurations of the primary-side winding 3a and the secondary-side windings 3b, 3c are the same as those in the first embodiment.

In the first embodiment, an example in which the number of winding turns of the primary-side winding 3a is changed between 6 and 12 has been described. The number of winding turns of the primary-side winding 3a need not be set to a multiple of 3, with the number of winding turns of each of the additional division windings of the primary-side winding 3a set to three. As shown in FIG. 10, the number of winding turns of the primary-side winding 3a may be set to 5 or 10, for example.

The primary-side winding 201 is wound by three turns, and has the inner-side end portion 2011 provided with a bent structure toward the direction of the primary-side winding 202. A primary-side winding 205 is wound by two turns, and has an inner-side end portion 2051 provided with a bent structure toward the direction of the primary side winding 201. The inner side end portion 2011 and the inner-side end portion 2051 are disposed on the center core side with respect to the inner-side part in the winding direction of the secondary-side winding 301, and are connected to each other by welding, for example. A primary-side winding 206 is wound by two turns, and has an inner-side end portion 2061 provided with a bent structure toward the direction of the primary-side winding 204. The primary-side winding 204 is wound by three turns, and has the inner-side end portion 2041 provided with a bent structure toward the direction of the primary-side winding 206. The inner-side end portion 2061 and the inner-side end portion 2041 are disposed on the center core side with respect to the inner-side part in the winding direction of the secondary-side winding 302, and are connected to each other by welding, for example.

End portions of the two extending members of the division winding 3a 1 are connection terminals 2012, 2052. End portions of the two extending members of the division winding 3a2 are connection terminals 2062, 2042. The extending members respectively have bent portions 2013, 2053, 2063, 2043 bent in the direction of the substrate (not shown in FIG. 10) . Similar to the first embodiment, when the division windings 3a1, 3a2 are connected in series by the substrate, the number of winding turns of the primary side winding 3a becomes 10. When the division windings 3a1, 3a2 are connected in parallel by the substrate, the number of winding turns of the primary-side winding 3a becomes 5.

With respect to the wound part, of the primary-side windings 203, 206, a clearance is provided between windings of each turn, and the winding width is increased such that the outer shapes of the primary side windings 205, 206 are aligned with those of the primary-side windings 201, 204, when viewed in the extending direction of the center core. With this configuration, when five turns are formed by the primary-side windings 201, 205, increase in loss in the primary-side winding due to increase in the primary-side current can be suppressed when compared with a case where six turns are formed by the primary-side windings 201, 202.

In the primary-side windings 205, 206, the inner-side end portions 2051, 2061, the extending members, and the connection terminals 2052, 2062, which are the parts other than the wound parts, have the same configurations as those of their corresponding parts of the primary-aide windings 202, 203 shown in the first embodiment. Therefore, without changing the outer shape and connection of the transformer 3, the number of turns can be changed by merely changing the winding members. In this example, changing from three turns to two turns has been shown. However, when winding members that each have one or more turns and that have the same structures as those of the inner-side end portions 2051, 2061, the extending members, and the connection terminals 2052, 2062, except the wound parts, are prepared, and winding members are selected, any number of primary turns N1 can be coped with.

In the present embodiment, the numbers of winding turns of the winding members forming the primary-side winding 3a are different. When compared with the primary-side windings 205, 206, the primary-side windings 201, 204 have a large number of turns and thus have a large heat generation amount. It is preferable that the primary-side windings 201, 204 are disposed at the lowest layer and the highest layer, in the extending direction of the center core of the transformer 3, which are closer to the cooler 501 or the cooling plate 504 shown in the second embodiment. When the primary-side windings 201, 204 are disposed at the lowest layer and the highest layer, coolability of the transformer 3 is improved, and thus, the transformer 3 can toe downsized. While the primary-side winding 201, the secondary -side winding 301, and the primary-side winding 205 are considered as one set, and when the bent portions 2043, 2063 and the substrate wirings (not shown in FIG. 10) are changed so as to realize the primary side winding 204, the secondary side winding 302, and the primary-side winding 206, which are the one set being disposed upside-down, the winding members can be used in common.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 DC power supply

2 single-phase inverter

2a, 2b, 2c, 2d semiconductor switching element

3 transformer

3a primary-side winding

3b secondary-side winding

3c secondary-side winding

3a1 division winding

3a2 division winding

4 rectification circuit

4a, 4b diode

5 reactor

6 smoothing capacitor

7 load

100 power conversion device

101 lower core

102 upper core

202, 202, 203, 204, 205, 206 primary-side winding

2021, 2021, 2032, 2041, 2051, 2061 inner-side end portion

2012, 2022, 2032, 2042, 2052, 2062 connection terminal

2013, 2023, 2033, 2043, 2053, 2063 bent portion

301, 302 secondary-side winding

3011, 3012, 3021, 3022 terminal

401 substrate

411, 412, 413, 414 through-hole

421, 422, 424, 425, 426 substrate wiring

501 cooler

502, 503, 506, 506 heat dissipation member

504 cooling plate

505, 507, 509 extension portion

510 resin member

What is claimed is:

1. A transformer comprising:
a core portion for forming a magnetic circuit; and
a primary-side winding and a secondary-side winding wound at the core portion, wherein
one or both of the primary-side winding and the secondary-side winding are divided into a plurality of division windings, and each of the plurality of the division windings of the at least one divided winding has a wound part wound at the core portion, and two extending members extending from both ends of the wound part, and
the extending members of the plurality of the division windings of the at least one divided winding are mutually connected, and a number of turns in the transformer of the at least one divided winding is set.

2. The transformer according to claim 1, comprising
a connection member, wherein
the connection member mutually connects the extending members of the plurality cf the division windings of the at least one divided winding, and sets the number of turns in the transformer of the at least one divided winding, by a connection pattern.

3. The transformer according to claim 2, wherein
a winding, out of the primary-side winding and the secondary-side winding, in which at. least current that flows in the wound part is smaller is the plurality of the division windings oil the at least one divided winding.

4. The transformer according to claim 2, wherein
the plurality of the division windings of the at least one divided winding have a same number of winding turns and a same winding direction with each other, and
the connection member mutually connects the extending members, in series ox: in parallel, of the plurality of the division windings of the at least one divided winding.

5. The transformer according to claim 3, wherein
the primary-side winding and the secondary-side winding are formed by a plurality of winding members,
each of the plurality of the winding members is formed in a shape of a plate that is curved on a same plane orthogonal to an extending direction of a part, of the core portion, around which the windings arc wound, and each surface of the plate is orthogonal to the extending direction, and
the plurality of the winding members are stacked in the extending direction.

6. The transformer according to claim 5, comprising
a cooling member, wherein
the core portion is thermally connected to the cooling member.

7. The transformer according to claim 5, wherein
the winding, out of the primary-side winding and the secondary-side winding, in which at least current that flows in the wound part is smaller is the plurality of the division windings of the at least one divided winding, and
end portions of the respective extending members of the plurality of the division windings have a same shape.

8. The transformer according to claim 5, wherein
the winding, out of the primary-side winding and the secondary-side winding, in which at least current that flows in the wound part is smaller is the plurality of the division windings of the at least one divided winding, and
each of the plurality of the division windings has a plural number of winding turns, in at least one layer.

9. The transformer according to claim 5, wherein
the winding, out of the primary-side winding and the secondary-side winding, in which at least current that flows in the wound part is smaller is the plurality of the division windings of the at least, one divided winding, and
when viewed in the extending direction of the part, of the core portion, around which the windings are wound, the respective division windings being at least two divisions are disposed on one side and another side of a winding in which current that flows in the wound part is larger.

10. The transformer according to claim 8, wherein
the division windings are each formed by two additional division windings being further divisions thereof, and
the two additional division windings are disposed at positions different from each other in the extending direction of the part, of the core portion, around which the windings are wound.

11. The transformer according to claim 10, wherein
each of the two additional division windings has a plural number of winding turns, and is formed in a shape of a plate that is curved, on a same plane orthogonal to the extending direction, in a spiral shape around a center of the core portion, and each surface of the plate is orthogonal to the extending direction,
end portions on sides closer to the core portion of the two additional division windings are mutually connected, and
the two extending members extend from end portions on aides farther from the core portion of the two additional division windings.

12. The transformer according to claim 10, wherein
the two additional division windings are each the winding, out of the primary-side winding and the secondary-side winding, in which at least current that flows in the wound part is smaller, and
a winding, out of the primary-side winding and the secondary-side winding, in which at least current that flows in the wound part is larger is disposed between the two additional division windings m the extending direction.

13. The transformer according to claim 6, wherein
the winding, out of the primary-side winding and the secondary-side winding, in which at least current that flows in the wound part is smaller is the plurality of the division windings of the at least one divided winding, and
the division winding, out of the plurality of the division windings, that has a maximum number of winding turns is disposed so as to be closest to the cooling member.

14. The transformer according to claim 13, wherein
an order of stacking the plurality of the winding members of the primary-side winding and the secondary-side winding is in symmetry with respect to a center in a direction of the stacking.

15. The transformer according to claim 9, wherein
the winding, out of the primary-side winding and the secondary-side winding, in which at least current that flows in the wound part is smaller is the plurality of the division windings of the at least one divided winding,
each of the plurality of the division windings has a same number of turns and a same winding direction,
the plurality of the division windings are respectively disposed at positions different from each other in the extending direction of the part, of the core portion, around which the windings are wound,
the extending member on a winding start side of each of the plurality of the division windings is electrically connected at the connection member, and
the extending member on a winding end side of each of the plurality of the division windings is electrically connected at the connection member.

16. The transformer according to claim 6, wherein
a winding, out of the primary-side winding and the secondary-side winding, in which current that flows in the wound part is larger, has a part directly or indirectly thermally connected to the cooling member.

17. The transformer claim 2, wherein
the connection member is a substrate.

18. The transformer according to claim 17, wherein
the substrate is disposed so as to overlap the extending members, when viewed in an extending direction of a part, of the core portion, around which the windings are wound,
each of the extending members has a bent portion bent in a direction of the substrate, and
when viewed in the extending direction of the part, of the core portion, around which the windings are wound, each of the extending members provided, so as to overlap, of each of the plurality of the division windings is provided with the bent portion at a different position.

19. The transformer according to claim 18, wherein
when viewed in the extending direction of the part, of the core portion, around which the windings are wound, the substrate is disposed on one side or another side with respect to the primary-side winding and the secondary side winding.

20. The transformer according to claim 2, wherein
the core portion includes: an outer peripheral core having an annular shape; and a center core having a columnar shape and connecting two parts opposed to each other in the outer peripheral core, and
the primary-side winding and the secondary-side winding are wound around the center core.

21. A power conversion device comprising:
a plurality of semiconductor switching elements which are connected to a DC power supply and which convert inputted DC power to AC power and output the AC power;
the transformer, according to claim 2, which converts voltage of the AC power outputted from the plurality of the semiconductor switching elements and outputs resultant voltage; and
a rectification circuit which rectifies output of the transformer.

22. The power conversion device according to claim 21, wherein
the connection member is implemented by a substrate, and
a part of circuits forming the power conversion device is mounted on the substrate.

23. A product group of a transformer, the product group comprising:
a first transformer including
a core portion for forming a magnetic circuit;
a primary-side winding and a secondary-side winding wound at the core portion; and
a first connection member, wherein
one or both of the primary-side winding and the secondary-side winding are divided into a plurality of division windings, and each of the plurality of the division windings of the at least one divided winding has a wound part wound at the core portion, and two extending members extending from both ends of the wound part, and
the first connection member mutually connects the extending members, in series, of the plurality of the division windings of the at least one divided winding, and seta a number of turns in the transformer of the at least one divided winding, by a series connection pattern; and
a second transformer including
a core portion that has a same configuration as that of the first transformer,
a primary-side winding and a secondary-side winding that, have same configurations of those of the first transformer, and
a second connection member, wherein
the second connection member mutually connects the extending members, in parallel, of the plurality of the division windings of the at least one divided winding, and sets a number of turns in the transformer of the at least one divided winding, by a parallel connection pattern.

24. A manufacturing method for a transformer, the manufacturing method comprising:
a member preparation step of preparing a core portion for forming a magnetic circuit, a primary-side winding and a secondary-side winding, and a connection member;
a winding step of winding the primary-side winding and the secondary-side winding at the core portion; and
a connecting step of connecting one or both of the primary-side winding and the secondary-side winding to the connection member, wherein
in the member preparation step, the primary side winding and the secondary-side winding in which one or both of the primary-side winding and the secondary-side winding are divided into a plurality of division windings, and each of the plurality of the division windings of the at least one divided winding has a wound part wound at the core portion, and two extending members extending from both ends of the wound part, are prepared as the primary-side winding arid the secondary side winding, and
in the connecting step,
a first connecting step of mutually connecting the extending members, by the connection member in series, of the plurality of the division windings of the at least one divided winding, and of setting a number of turns in the transformer of the at least, one divided winding, by a series connection pattern of the connection member, and
a second connecting step of mutually connecting the extending members, by the connection member in parallel, of the plurality of the division windings of the at least one divided winding, and of setting a number of turns in the transformer of the at least one divided winding, by a parallel connection pattern of the connection member,
are executed.
